(19) United States
(12) Patent Application Publication
(10) Pub. No.: US 2007/0059955 A1
(43) Pub. Date: Mar. 15, 2007

(54) Media conversion for telephonic mobile devices

(75) Inventor: Brian J. Leno, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Phone Sherpa Inc., Seattle, WA (US)

(21) Appl. No.: 11/519,339

(22) Filed: Sep. 11, 2006

Related U.S. Application Data
(60) Provisional application No. 60/717,333, filed on Sep. 15, 2005.

(51) Int. Cl. H01R 13/44

(52) U.S. Cl. 439/131

(57) ABSTRACT

A server-based process, which includes a process whose execution is primarily on a shared remote computer such as a Web server or remote database, allows ring tones to be created and images to be edited for use on telephonic mobile devices. A tag that inhibits caching is attached to the end of messages so as to tunnel through telecommunication equipment and a concurrent, asynchronous process architecture is used to increase robustness of the uploading, editing, and converting services.

### CROSS-REFERENCE TO RELATED APPLICATION

This application claims the benefit of U.S. Provisional Application No. 60/717,333, filed Sep. 15, 2005, which is incorporated herein by reference.

### TECHNICAL FIELD

The technical field relates generally to software, and more particularly, to converting media contents on a remote server for downloading to mobile devices.

### BACKGROUND

A typical scenario for phone personalization is as follows. A customer uses a computer to find an aftermarket content provider Web site. The customer goes to the Web site and browses a catalog of pre-made ring tones and wallpaper. The customer selects the content he wants and either pays for it with a credit card or instructs the content provider to bill the customer's cellular provider directly (which then appears on his monthly statement). The Web site then sends the selected content to the customer's cellular device via SMS, WAP Push, or MMS messaging. The details of the transport are not important to the customer; he only passively experiences the selected content being wirelessly transferred to his cellular device.

It is important to point out that a vast majority of aftermarket content providers sell pre-made content. That is, they offer catalogs of content from which to choose. If they do not have what a customer is looking for, however, then it is not possible for the customer to purchase the desired content.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter. In accordance with this invention, a method, storable computer-readable medium, and a system for media conversion are provided.

The method form of the invention includes a computer-implemented method for converting media, which comprises navigating to a Web site at which a piece of conversion software is running; selecting a media file stored on a local computer using the conversion software; uploading the media file to the Web site using the conversion software; editing the contents of the uploaded media file to obtain a desired portion; and converting the desired portion of the uploaded media file into a piece of media usable on a telephonic mobile device and sending a link that points to the desired portion for the telephonic mobile device to download using a tag that inhibits caching.

In accordance with further aspects of this invention, a storable computer-readable medium form of the invention includes a storable computer-readable medium having computer-executable instructions stored thereon for implementing a computer-implemented method for converting media, which comprises navigating to a Web site at which a piece of conversion software is running; selecting a media file stored on a local computer using the conversion software; uploading the media file to the Web site using the conversion software; editing the contents of the uploaded media file to obtain a desired portion; and converting the desired portion of the uploaded media file into a piece of media usable on a telephonic mobile device and sending a link that points to the desired portion for the telephonic mobile device to download using a tag that inhibits caching.

In accordance with further aspects of this invention, a system form of the invention includes a networked system for converting media, which comprises a telephonic mobile device; a local computer usable to connect to a Web site that runs conversion software; and a server on which the Web site is hosted for uploading a media file from the local computer to the Web site using the conversion software that edits and converts the media file into a piece of media usable by the telephonic mobile device when the piece of media is sent to the telephonic mobile device using a tag that inhibits caching.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrating an exemplary system for facilitating the conversion of media contents for a telephonic mobile device, according to one embodiment of the present invention;

FIG. 2A is a pictorial diagram of an exemplary Web service usable for uploading an audio track from a local computer onto a Web server, according to one embodiment of the present invention;

FIG. 2B is a pictorial diagram of an exemplary Web service usable for editing an audio track on a server, according to one embodiment of the present invention;

FIG. 2C is a pictorial diagram of an exemplary Web service usable for sending a converted portion of an audio track to a telephonic mobile device, according to one embodiment of the present invention;

FIG. 3A is a pictorial diagram of an exemplary Web service usable for uploading an image from a local computer onto a Web server, according to one embodiment of the present invention;

FIG. 3B is a pictorial diagram of an exemplary Web service usable for editing and sending a portion of the image to a telephonic mobile device, according to one embodiment of the present invention;

FIGS. 4A-4H are process diagrams illustrating an exemplary method for customizing a ring tone for a telephonic mobile device, according to one embodiment of the present invention; and

FIG. 5A is a process diagram illustrating an exemplary method for customizing an image for a telephonic mobile device, according to one embodiment of the present invention.

### DETAILED DESCRIPTION

Various embodiments of the present invention focus on server-based media conversion hardware and software without the need for users to download and run local software on their computers. Server-based media conversion allows the latest accommodation of models of telephonic mobile device and media formats, and avoids the intrusion and security issues that users of current Web services abhor. Additionally, the server-based media conversion can be used anywhere and not necessarily on the users' own computers because the server-based media conversion can be accessed from multiple locations.

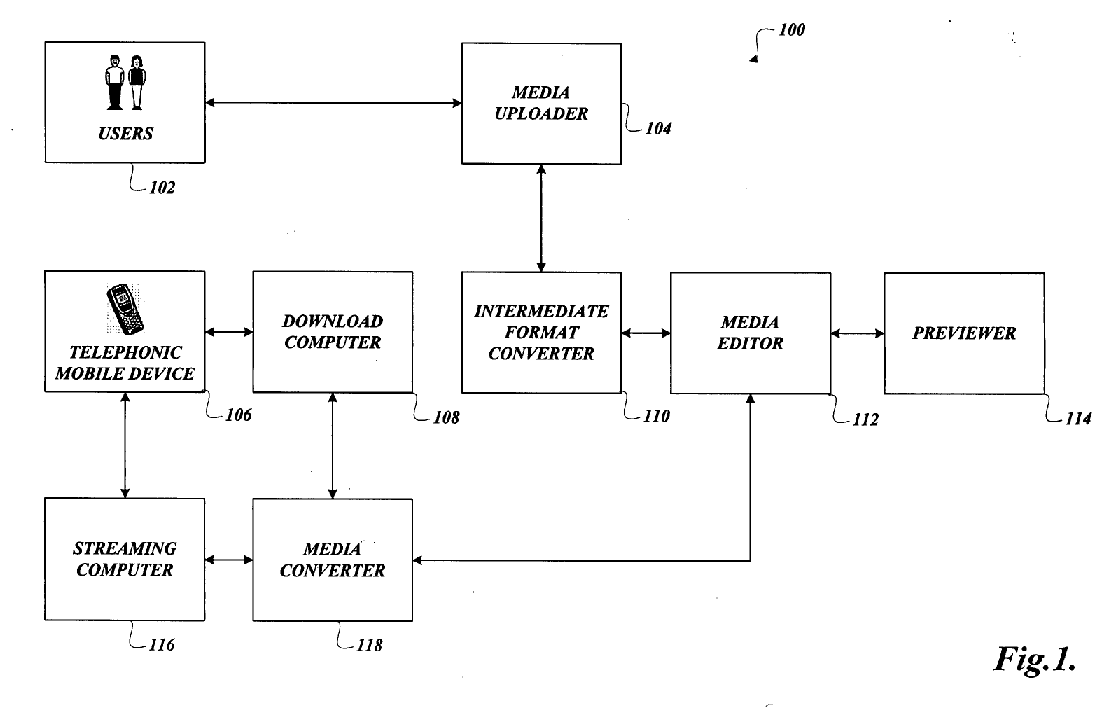

FIG. 1 illustrates a system 100 for facilitating the conversion of media contents, such as audio, images, video, and so on, for a telephonic mobile device 106. The system 100 operates using server-based pieces of hardware and software, hence avoiding the need for users 102 to download or install software that runs on a local computer. The telephonic mobile device 106 includes a cellular phone but other suitable devices may include a pocket personal computer, a personal digital assistant, and so on.

Conventional cellular phones typically come with pre-installed content, such as ring tones, wallpaper images, and screensavers. Additional pre-made pieces of content can be purchased separately by the users 102. Various embodiments of the present invention focus on allowing the users 102 to customize these pieces of content from existing audio tracks, images, or video. For example, suppose the users 102 have an audio file on their computer in an appropriate format, such as the MP3 format. Using the system 100, the users 102 can take a segment of that audio file, package it up, and format it in a way that is suitable for the telephonic mobile device 106. In this way, the choices of the users 102 become virtually unlimited or limited to the media files that are available to them. Unlike conventional pre-made or pre-installed content, various embodiments of the present invention allow a ring tone to be created for a different part of a song or a portion of the image desired by the users 102. The sources for customization include both personally-created content as well as purchased content in any suitable formats. Customization as provided by various embodiments of the present invention allows the personalization of the telephonic mobile device 106.

In an exemplary scenario, the users 102 access the system 100 preferably through the Internet. A media uploader 104 presents a user interface through the Web browser running on a computer of the users 102. The user interface allows the users 102 to search for a piece of media with which a portion will be edited and transformed into another piece of content that is suitable for use on the telephonic mobile device 106 as a ring tone, a wallpaper, a video clip, and so on. When the users 102 select a hyperlink or a button provided by the media uploader 104 signifying the desire to upload the piece of media to the system 100, the media uploader 104 uploads the piece of media and presents the piece of media to an intermediate format converter 110.

The intermediate format converter 110 transforms the piece of media into an intermediate format that can be efficiently processed by the system 100. A media editor 112 processes the converted piece of media now in the intermediate format into a visual form that can be presented to the users 102 along with an editing user interface. Using the editing user interface, the users 102 select a portion of the converted piece of media for further processing. A previewer 114 can be accessed via a hyperlink or a button by the users 102 to see the portion of the piece of media before further processing. When the users 102 are satisfied with the selected portion of the piece of media, the media editor 112 presents the portion to a media converter 118 for further processing. The media converter 118 converts the selected portion of the piece of media into a format that is appropriate to the model of the telephonic mobile device 106.

For certain types of media, such as audio and images, the media converter 118 presents the converted portion of the piece of media to a download computer 108. The download computer 108 communicates with the telephonic mobile device 106 by providing a link or other suitable form of uniform resource locator information. When the users 102 select upon the link, the telephonic mobile device 106 downloads the converted portion piece of the media from the download computer 108. Other converted portions of the piece of media may better be stored on the system 100 and streams to the telephonic mobile device 106. For other types of media, such as video, a streaming computer 116 streams the converted portion of the piece of media depending on the media type, such as video, to the telephonic mobile device 106.

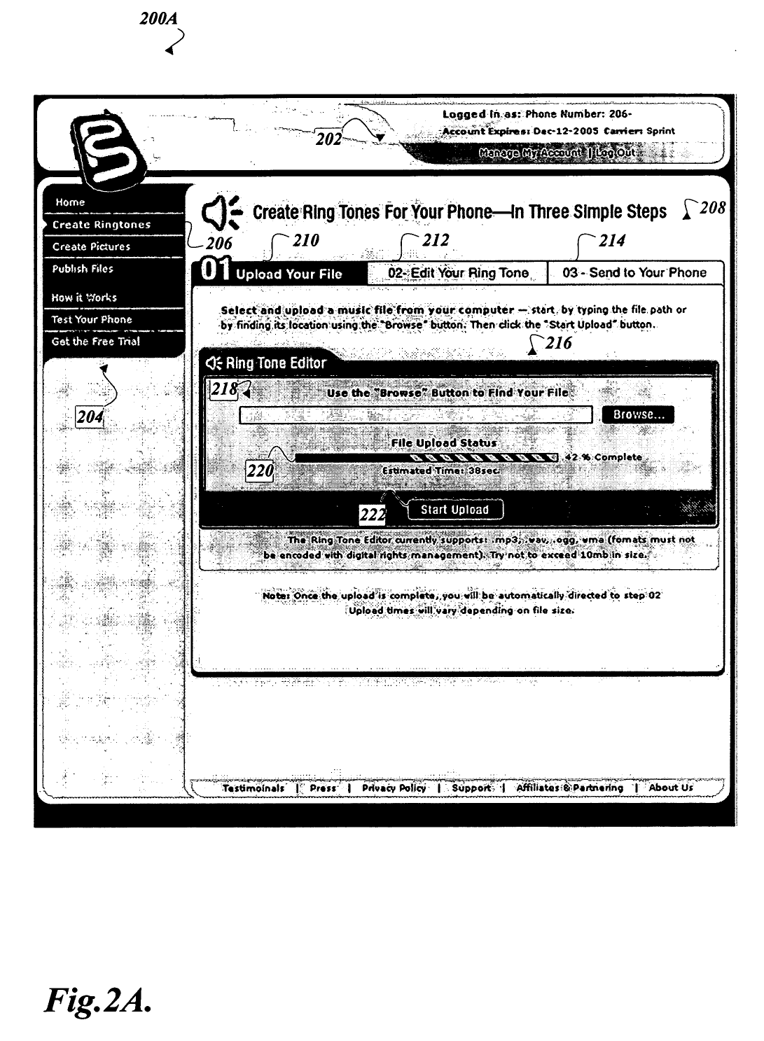

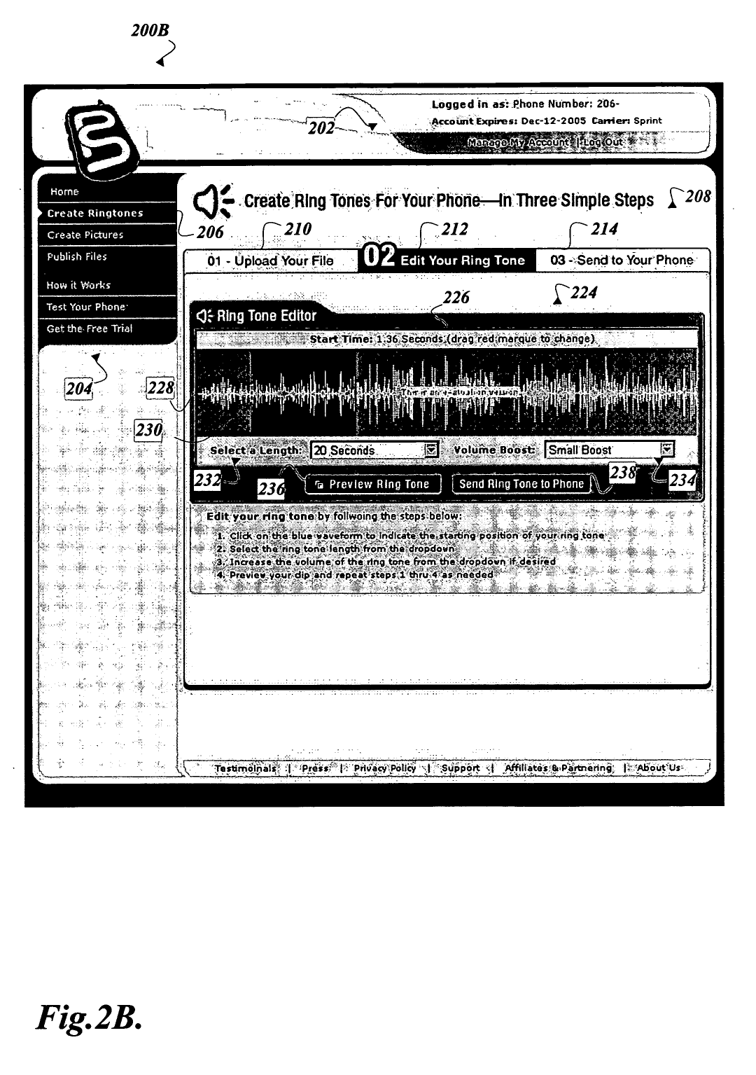

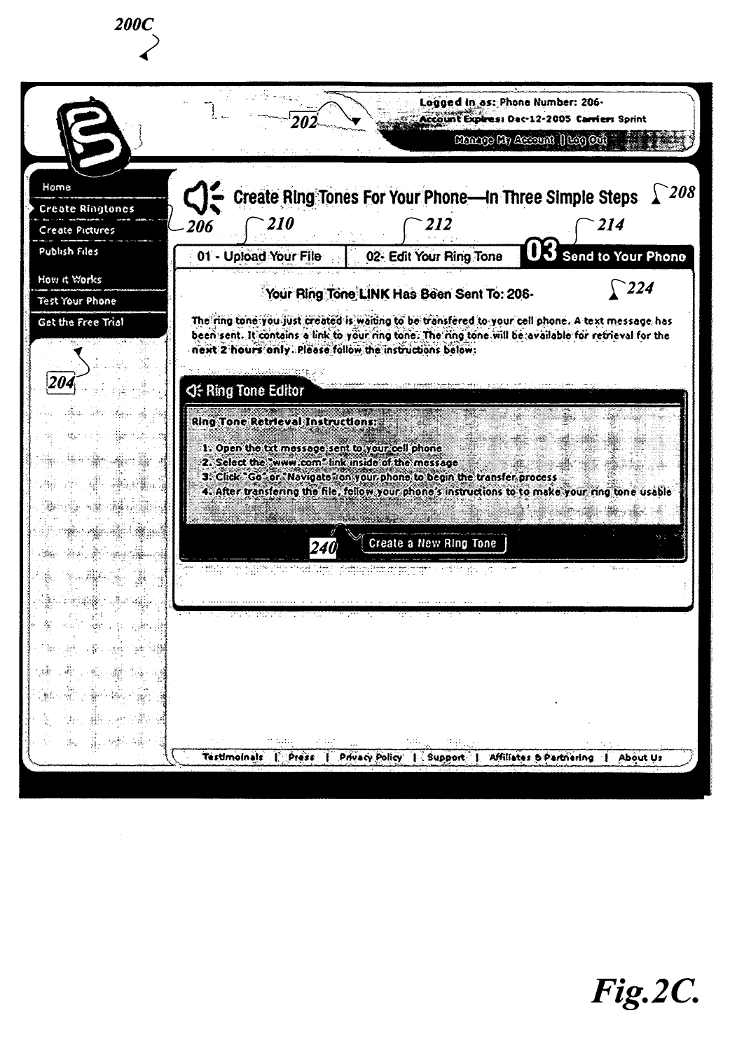

FIG. 2A illustrates a user interface 200a that is presented to the users 102 by the media uploader 104 so as to allow pieces of media to be uploaded to the system 100 for processing. The user interface 200a includes a collection 202 of textual elements as well as hyperlinks. An example textual element includes “Logged in As:”, which describes a specific telephone number of the telephonic mobile device 106 belonging to the users 102. Another textual element includes “Account Expires:”, which describes a date on which an account connected with the users 102 of the system 100 expires. A third textual element “Carrier” describes a telecommunications carrier servicing the telephonic mobile device 106.

Two hyperlinks are also presented, one being “Manage My Account” and the other being “Log Out”. The hyperlink “Manage My Account” allows the users 102 to modify various pieces of information connected with the account and the hyperlink “Log Out” allows the users 102 to terminate the session with the system 100. A collection 204 of hyperlinks navigates the users 102 to various Web pages connected with the system 100, such as hyperlink “Home”, which brings the user to a home page of the system 100; hyperlink 206 “Create Ring Tones”, which brings the users 102 to a collection of Web pages connected with creating ring tones; hyperlink “Create Pictures”, which allows the users 102 to access Web pages to create pictures for the telephonic mobile device 106; hyperlink “Publish Files”, which allows the users 102 to make public various files; hyperlink “How It Works”, which brings the users 102 to various Web pages to understand how various services of the system 100 work; hyperlink “Test Your Phone”, which brings forth various Web pages to test the telephonic mobile device 106; and hyperlink “Get The Free Trial”, which allows the users 102 to access a limited promotion for converting a number of ring tones or images via the system 100.

Upon selection of the hyperlink 206 “Create Ring Tones” the user interface 200a brings forth another user interface 208. The user interface 208 includes a graphic element which abstractly represents a speaker producing sound. It also includes a textual element “Create Ring Tones For Your Phone-In Three Simple Steps”. The user interface 208 includes several tabs 210-214, which bring forth various user interfaces when selected. Another textual element is “The Ring Tone Editor Currently Supports: .MP3, .WAV, .OGG, .WMA (formats must not be encoded with digital rights management). Try not to exceed 10 Mb in size.” which provides directions for various media types that are supported by the system 100 as well as some other requirements. Another textual element is “Note: Once The Upload Is Complete, You Will Be Automatically Directed To Step 02 Upload Times Will Vary Depending On File Size.”, which provides further directions in the use of a user interface 208.

When the tab 210 is selected, it is brought forth to the foreground of the user interface 200a. A textual element is presented to instruct the users 102 to use the user interface elements of the tab 210 for uploading a media file: “Select and upload a music file from your computer—start by typing the file path or by finding its location using the ‘BROWSE’ button. Then click the ‘Start Upload’ button.” A user interface 216 is embedded within the tab 210 containing several user interface elements to allow the users 102 to upload the media file. A collection 218 of user interface elements includes a textual element “use the ‘BROWSE’ button to find your file”, which instructs the users 102 to find a media file on their computer. A text box is part of the collection 218 allowing the users 102 to enter a path to a particular media file on their computer. Alternatively, a button titled “BROWSE . . . ” can be selected in the collection 218 to bring forth an Explorer window for the user to search for a particular media file. Subjacent to the collection 218 is a pictorial user interface element 220 that provides a status and an estimated time of completion for uploading a particular media file. A button 222 is titled “Start Upload”, which when selected by the users 102, begins the process of uploading a selected media file to the system 100.

When the tab 212 is selected, a user interface 224 is presented to the users 102. See user interface 200b. The user interface 224 includes a textual element 226 that indicates a start time for a portion of the audio track to be converted. In the example shown in FIG. 2B, the textual element 226 is presented as follows, “Start Time: 1.36 seconds (drag red marquee to change)”. The red marquee mentioned in the textual element 226 refers to the dashed box 230 covering a window of an audio track visually presented by a waveform 228. The users 102 can use a mouse to lengthen or shorten the dashed box 230 so as to capture a desired portion of the audio track 228. Alternatively, the users 102 may select a predetermined length using a drop down menu 232. Some audio tracks may have a volume that is too low before conversion, and the users 102 may use a drop down menu 234 to provide a suitable volume boost to the audio amplitude. A box “preview ring tone” 236 can be selected by the users 102 to render the selected portion of the audio track 228 as indicated by the box 230, causing the sound from the selected portion to be reproduced on the computer of the users 102 for verification. When the users 102 are satisfied with the selected portion of the audio track 228, a button 238 titled “Send Ring Tone To Phone” can be selected to cause the system 100 to convert the selected portion of the audio track 228 into a ring tone appropriate to the telephonic mobile device 106.

User interface 200c, as illustrated at FIG. 2C, shows that tab 214 has been selected. Upon selection of tab 214, a user interface 224 is presented indicating the phone number of the telephonic mobile device 106 that the ring tone was sent to. There are additional instructions for the users 102 to download the ring tone. If the users 102 decide to create a new ring tone, a button 240 which is appropriately named “Create A New Ring Tone” can be selected to begin the process over again.

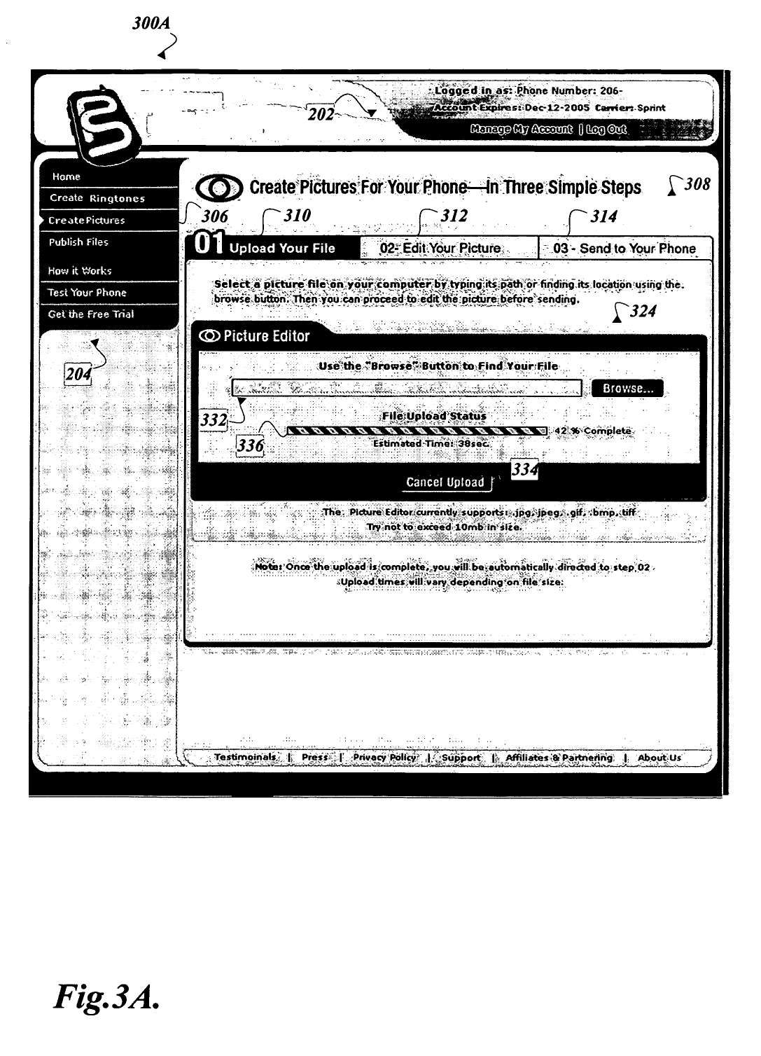

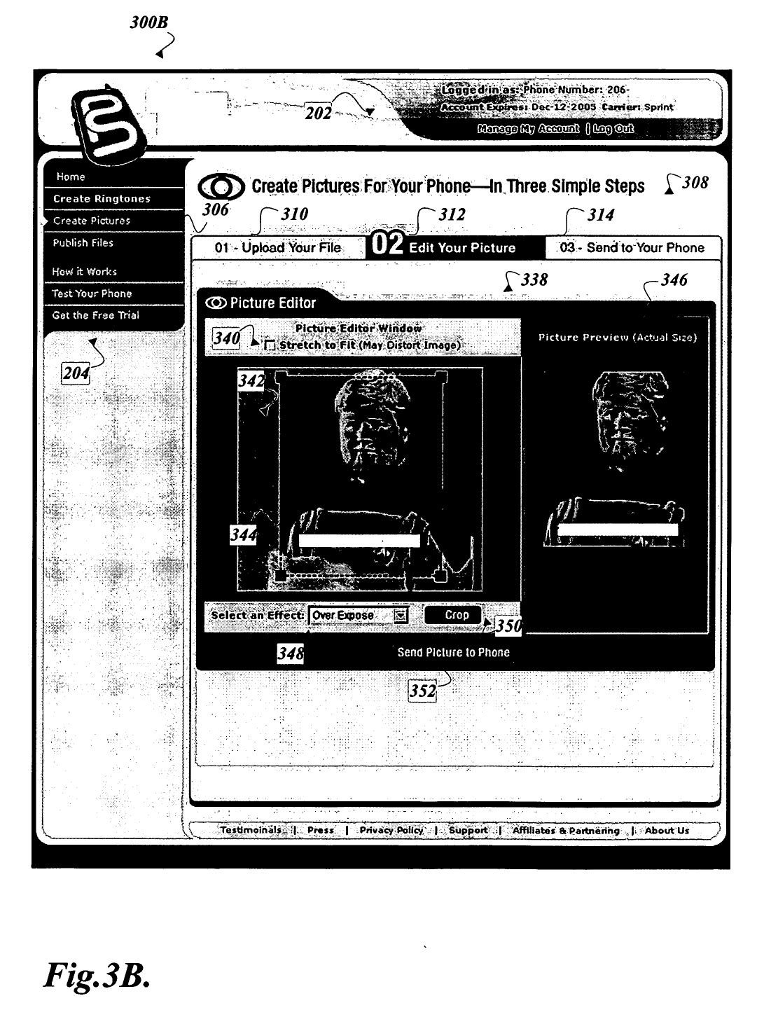

User interface 300a illustrated at FIG. 3A includes a number of elements similar to those discussed with respect to FIGS. 2A-2C and for brevity purposes they will not be repeated here. The user interface 300a is presented to the users 102 when a hyperlink 306 which is titled “Create Pictures” is selected by the users 102. A collection 308 of user interfaces is presented including tabs 310-314, all of which allow the users 102 to upload an image and a portion of which can be converted into a piece of wallpaper for the telephonic mobile device 106. FIG. 3A illustrates a scenario where tab 310 has been selected by the users 102. The tab 310 allows the users 102 to upload a media file containing a desired image. A user interface 324 is presented containing a collection of user interface elements to facilitate the uploading process. A collection 332 of user interface elements allows the users 102 to browse and find a media file containing the desired image. Part of the collection 332 is a text box in which the users 102 can enter a path pointing directly to the media file on their computer. Alternatively, a button called “BROWSE . . . ” can be selected to bring up an Explorer window allowing the users to graphically select the media file among various files in various directories on their computer. A graphical user interface element 336 indicates the upload status of a selected media file containing the desired image to the system 100. The graphical user interface 336 includes a bar indicating an approximate completion status as well as other numerical representations, both in terms of percentage and in terms of time toward completion of the uploading processing. A button 334 titled “Cancel Upload” can be selected by the users 102 to terminate the uploading process.

User interface 300b is illustrated at FIG. 3B. The tab 312 is selected and a picture editor user interface 338 is presented to the users 102. Inside the picture editor 338 is the image 342 that was contained in the media file uploaded to the system 100. A rectangular box 344 defines a portion of the image 342 to be converted for the telephonic mobile device 106. Each corner of the rectangular box 344 can be handled by the users 102 via a pointing device, such as a mouse, to change the dimensions of the rectangular box 344, hence affecting the portion to be converted from the image 342. A click box 340 can be selected by the users 102 to stretch the image 342 from its original dimensions to accommodate the entire dimension supported by the user interface 338. By doing so, it may distort the image because the aspect ratio of the original image 342 is not retained. Various effects can be applied to the portion of the image defined by the rectangular box 344. These effects can be selected by the pull down menu 348. One suitable effect includes overexposing the portion defined by the rectangular box 344. A preview window 346 displays the portion selected by the rectangular box 344, allowing the users 102 to immediately visualize the selected portion. When the users 102 are satisfied with the selected portion, a button 350 titled “CROP” can be selected to trim the image defined by the rectangular box 344. Subsequently, the users 102 may proceed to send the selected portion to the telephonic mobile device 106 by selecting the button 352 titled “Send Picture To Phone.”

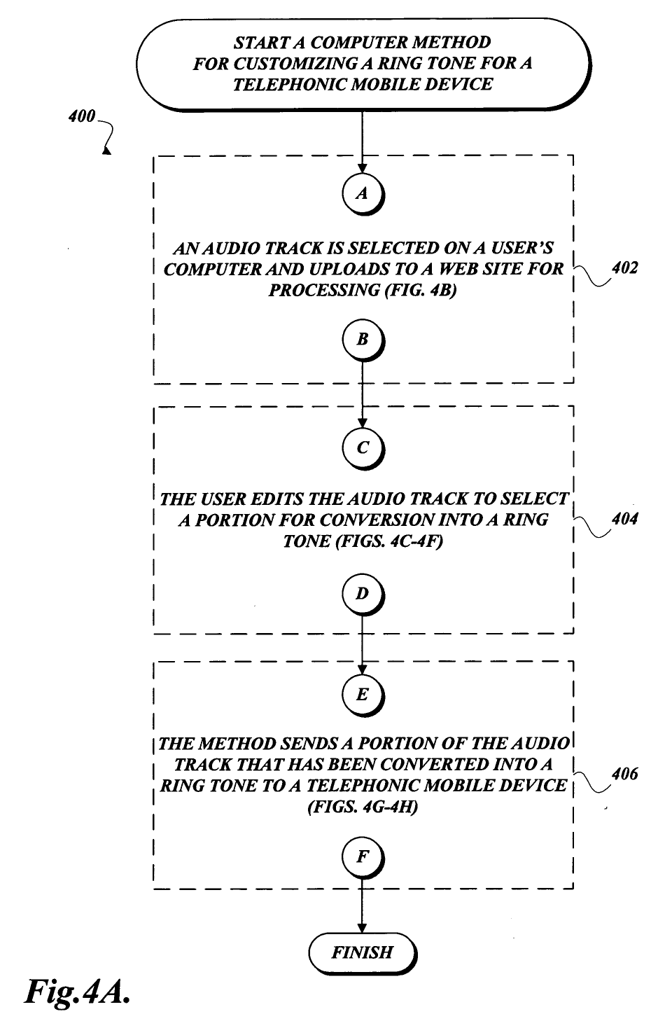

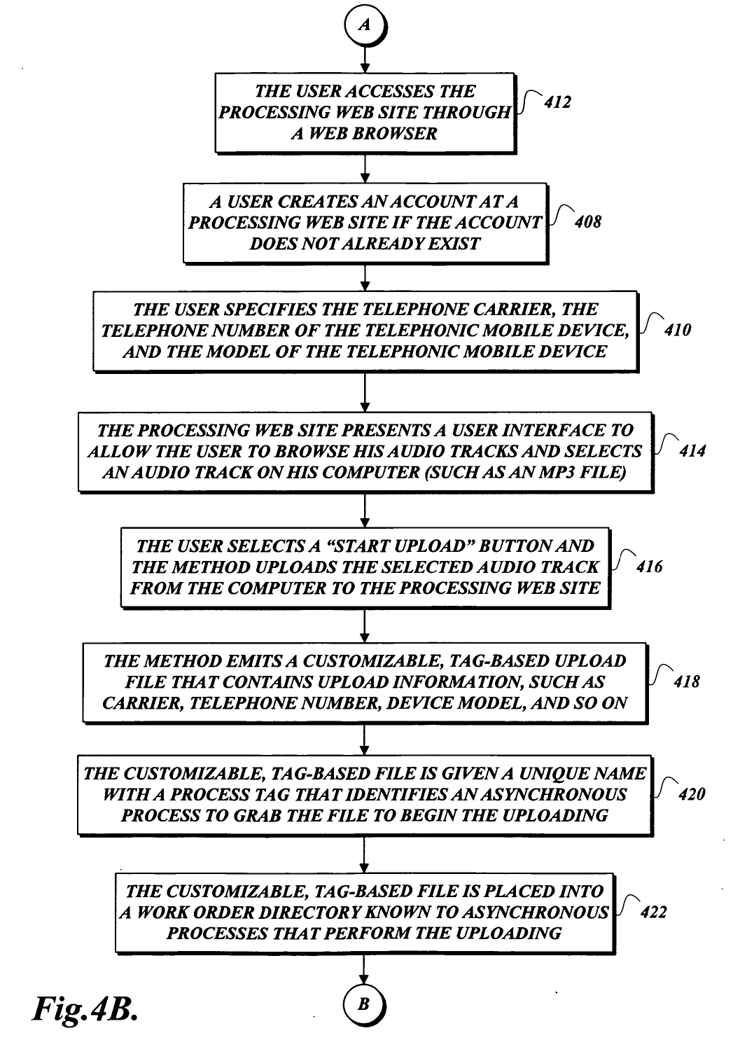

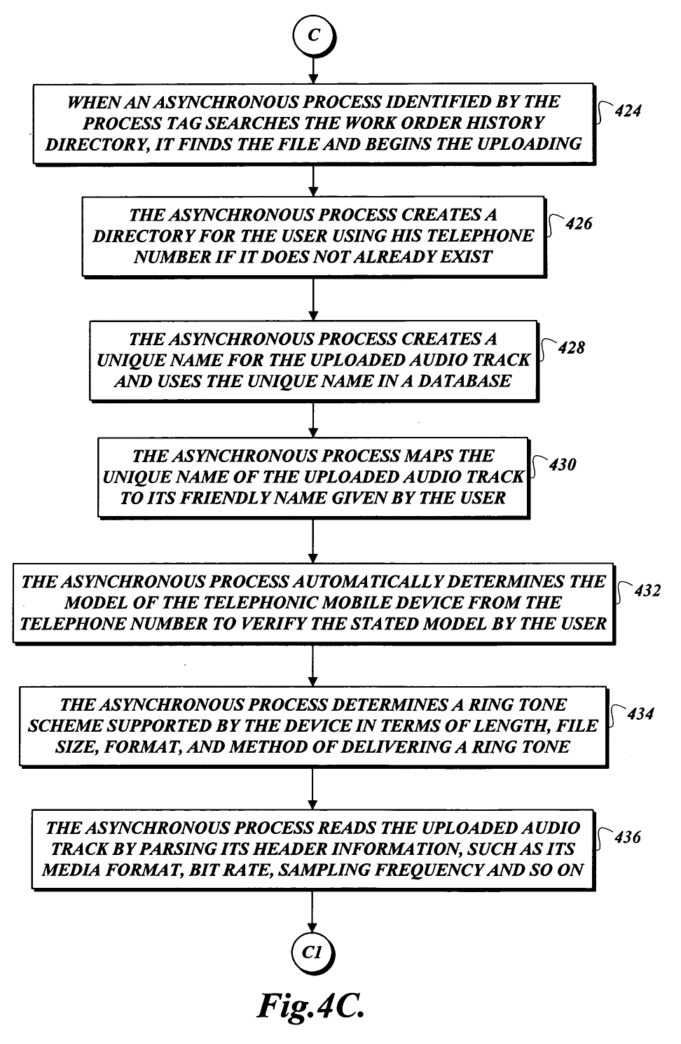

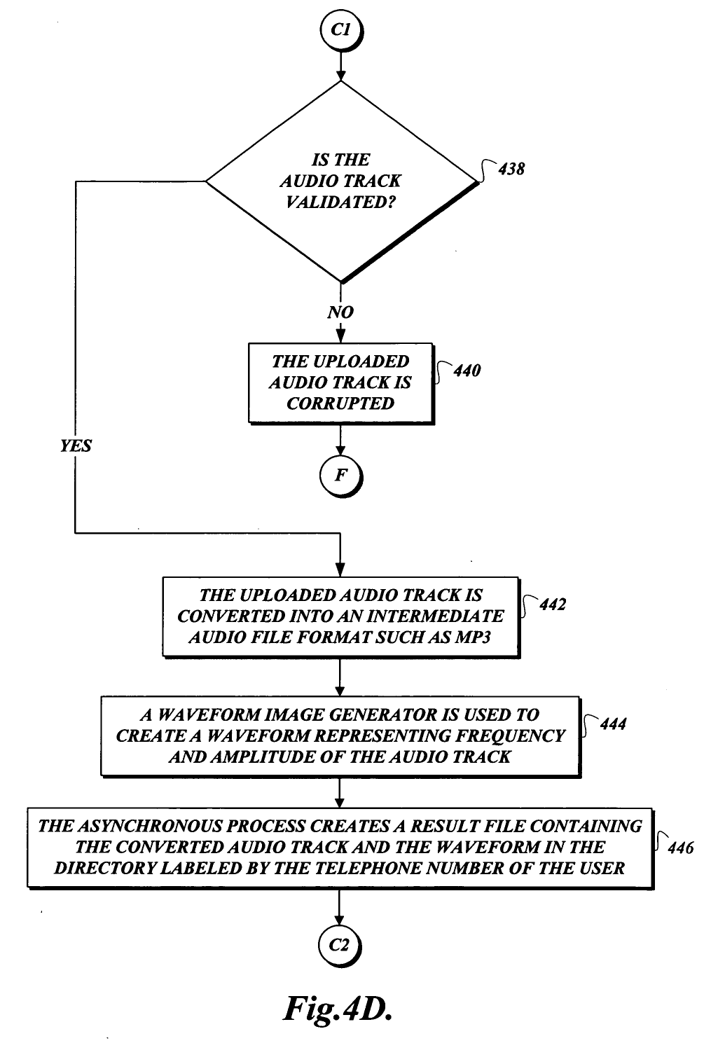

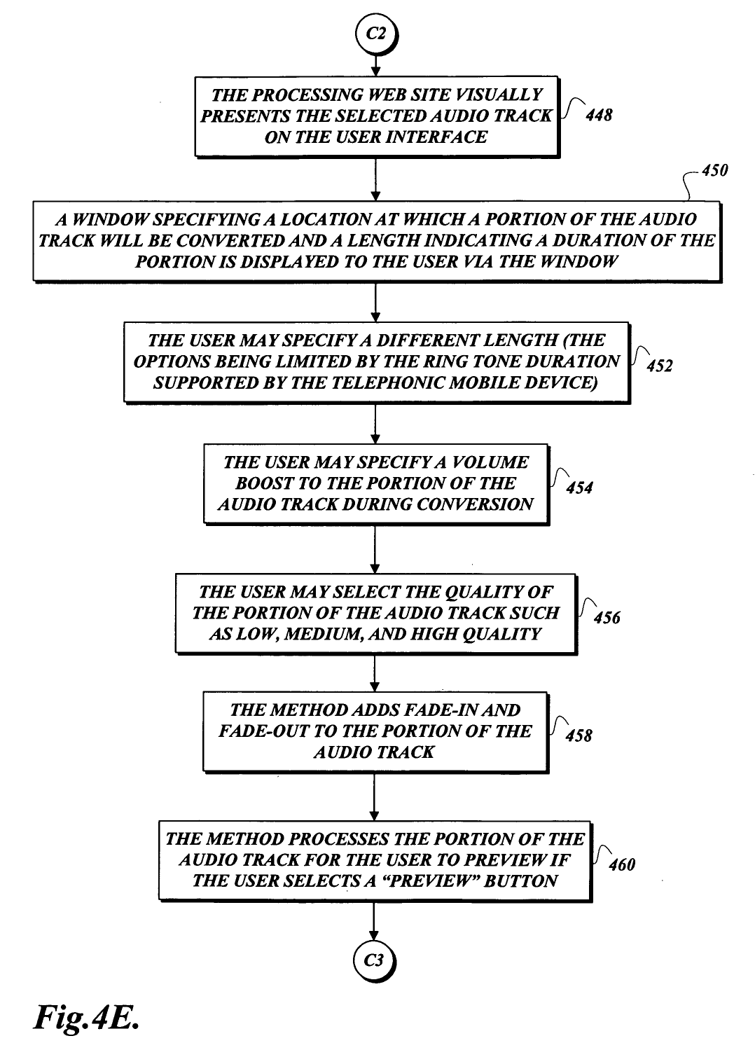

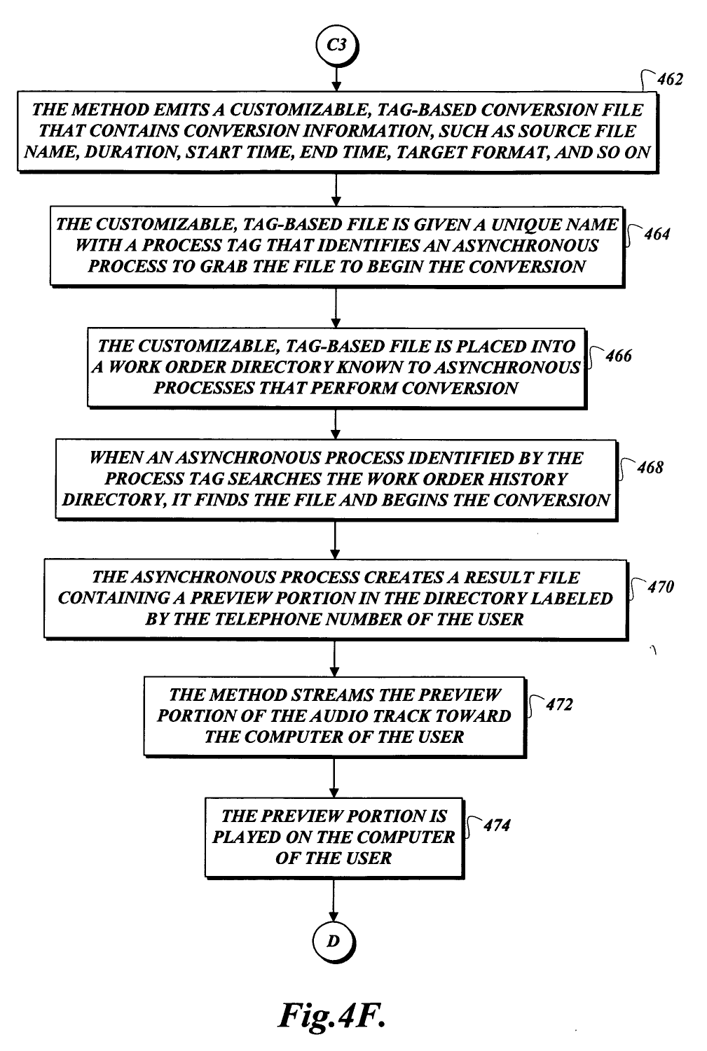

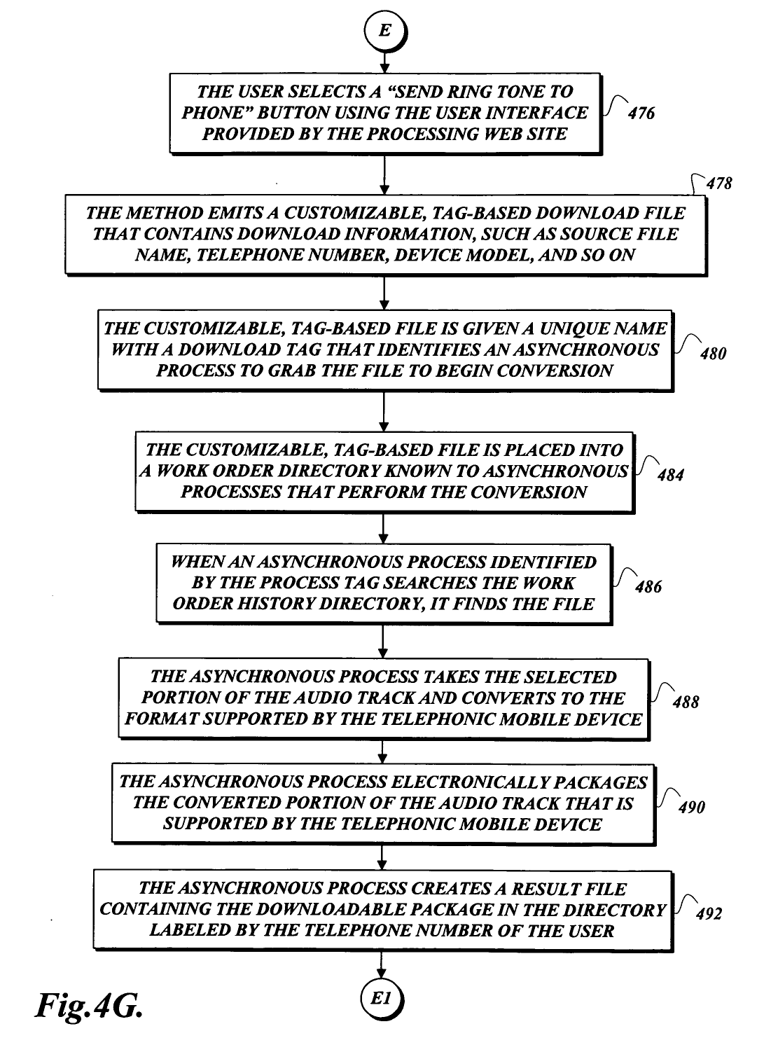

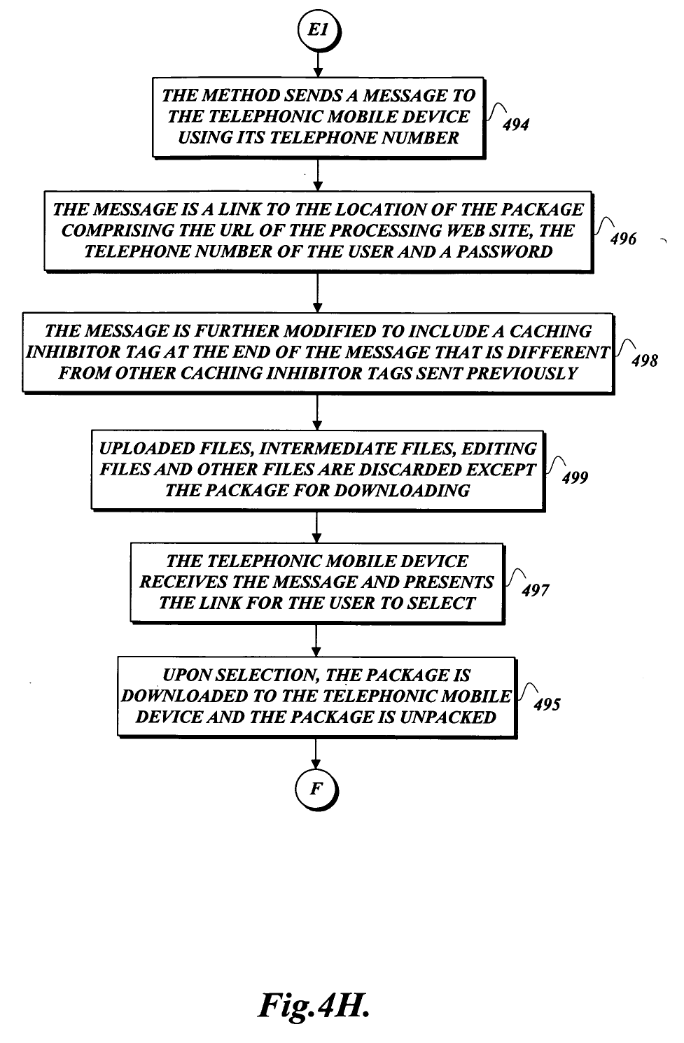

FIGS. 4A-4H illustrate a method 400 for customizing a ring tone for a telephonic mobile device. Unlike media conversion software that executes on a user's computer, media conversion Web services that are provided from a server typically accommodate many users who simultaneously or contemporaneously upload media content to the server, edit the media content, and download the converted content to many telephonic mobile devices. Files belonging to one user need to be segregated from other users to prevent collision. Various embodiments of the present invention accommodate many users by using concurrent, asynchronous processes and a directory architecture that separates one user from another user via telephone numbers. This architecture also works internationally because telephone number are unique. Additionally, there is a directory for uploading media and another for downloading converted media in addition to directories that are labeled by the telephone numbers of various users to store contents connected with those users. Preferably, when the user has finished by downloading a desired portion of the audio track or image or terminates the conversion session, various embodiments of the present invention remove all files except the result files, if any, from disks. But then the result files, which contain the final converted portion of the audio track or image, are kept for a limited amount of time, such as 24 hours, and are thereafter removed from the system. For example, every time a user decides to preview a selected portion of an audio track, a new file is created to contain the preview decided upon.

From a start block, the method 400 proceeds to a set of method steps 402, defined between a continuation terminal (“terminal A”) and an exit terminal (“terminal B”). The set of method steps 402 describes that an audio track is selected on a user's computer and uploads to a Web site for processing. From terminal A (FIG. 4B), the method 400 proceeds to block 412 where the user accesses the processing Web site of the system 100 through a Web browser on his computer. At block 408, a user, such as users 102, creates an account at a processing Web site such as the system 100, if the account does not already exist. At block 410, the user specifies the telephone carrier, the telephone number of the telephonic mobile device, and the model of the telephonic mobile device to the system 100.

Based on various pieces of information provided by the user responding to block 410, services on the system 100 can determine the format that the telephonic mobile device 106 supports in terms of length, file size, format, method of delivery, and so on. At block 414, the processing Web site presents a user interface to allow the user to browse his audio tracks and selects an audio track on his computer (such as an MP3 file). Services on the system 100 support a number of audio formats, such as MP3, WMA, various kinds of WAV encodings, AU, SND, AUC, MP4, and so on. As more formats are developed, a new decoding service can be added to the system 100 to accommodate these new formats of the audio tracks provided by the user. At block 416, the user selects a “Start Upload” button and the method uploads the selected audio track from the computer to the processing Web site at the system 100.

One with ordinary skill in the art would appreciate that various embodiments of the present invention provide one or more user interfaces from system 100 to a Web browser running on the user's computer. Various embodiments of the present invention need not download to the computer of the user programs that perform media conversion. Instead, services running on various servers remotely at the system 100 provide the bulk of the computational tasks. For example, the user may edit a portion of an audio track to select a portion of the audio track they wish to convert into a ring tone. Such editing functionality is provided remotely by the system 100 without downloading pieces of software on the computer of the user.

Block 414 allows the user to specify a path to the source file containing the media content and via the Web browser running on the user's computer, and block 416 can upload the source file to the system 100. To improve robustness and dealing with many users of the system 100, preferably various embodiments of the present invention use asynchronistic and concurrent processes to service the requests of the user. One such example is in servicing the uploading request by the user. At block 418, the method 400 emits a customizable, tag-based upload file that contains upload information such as carrier, telephone number, device model, and so on. One suitable customizable, tag-based language that is used to create the upload file is extensible markup language (XML). But other suitable customizable, tag-based languages can be used.

The customized, tag-based file is given a unique name with a process tag that identifies an asynchronous process that will grab the file to begin the uploading. See block 420. In other words, a file that reflects the instructions for uploading the source file is created and is placed into a location so that an asynchronous and distributed process can pick up the file and begin to work on it. At block 422, the customizable, tag-based file is placed into a work order directory known to asynchronous processes that perform the uploading. The method 400 then proceeds to the exit terminal B.

From terminal B (FIG. 4A), the method 400 proceeds to a set of method steps 404, defined between a continuation terminal (“terminal C”) and an exit terminal (“terminal D”). The set of method steps 404 describes that the user edits the audio track to select a portion for conversion into a ring tone.

From terminal C (FIG. 4C), the method proceeds to block 424 where an asynchronous process identified by the process tag searches the work order history directory and finds the file to begin the uploading. Using asynchronous processes enhances the robustness of the system 100. Suppose that the file picked up by the asynchronous process is corrupted or contains a virus; the asynchronous process can be shut down without affecting other asynchronous processes as well as other services provided by the system 100. The asynchronous process can also be resurrected by the system 100 to service the next uploading request by the user while terminating the previously corrupted session.

At block 426, the asynchronous process creates a directory for the user using his telephone number if it does not already exist. The asynchronous process creates a unique name for the uploaded audio track and uses the unique name in a database. See block 428. The asynchronous process maps the unique name of the uploaded audio track to its friendly name as given by the user. See block 430. At block 432, the asynchronous process automatically determines the model of the telephonic mobile device from the telephone number to verify the stated model by the user. At block 434, the asynchronous process determines a ring tone scheme supported by the device in terms of length, file size, format, and method of delivering a ring tone. The asynchronous process then reads the uploaded audio track by parsing its header information, such as its media format, bit rate, sampling frequency, and so on. See block 436. The method then continues to another continuation terminal (“terminal C1”).

From terminal C1 (FIG. 4D), the method proceeds to decision block 438 where a test is performed to determine whether the audio track is validated. If the answer to the test at decision block 438 is No, the method proceeds to block 440 where the uploaded audio track is considered corrupted. The method then proceeds to an exit terminal (“terminal F”), and terminates execution. If the answer to the test at decision block 438 is Yes, the method proceeds to block 442 where the uploaded audio track is converted into a suitable intermediate audio file format. One suitable intermediate audio file format includes MP3 but others may be used. These validation steps are preferably performed by various embodiments of the present invention so as to avoid corrupted files. One example is where a malicious user takes a file that may not contain audio information and renames it into a suffix of a particular audio type. Various embodiments of the present invention inhibit corrupted files by performing validation. At block 444, a waveform image generator is used to create a waveform representing the frequency and amplitude of the audio track. The waveform will be presented to the user so as to allow the user to have a kind of visual orientation about the area in the audio track the user wishes to extract as a ring tone. At block 446, the asynchronous process creates a result file containing the converted audio track and the waveform in the directory labeled by the telephone number of the user.

In an alternative embodiment, at block 446, the asynchronous process also determines the model of the telephonic mobile device. One reason among many reasons to determine the model is not only to determine the media formats that the model supports but also to determine the varying media qualities supported by the model. The quality is somewhat dependent on the size of the file supported by the model. Thus, high quality media may require larger files. The asynchronous process, after determining the model, also determines the preferred format supported by the model of the telephonic mobile device. Some models can support better media quality than other models. These determinations are preferably calculated on the system 100 and not on the computer of the user. The method then continues to another continuation terminal (“terminal C2”).

At block 444, the asynchronous process knows the maximum size of the editing screen to be presented to the user, such as the screen presented by the user interface 224 at FIG. 2B. Assuming that the maximum size is 600 pixels for the sake of discussion, the waveform 228 that is generated by the waveform image generator is represented by 600 pixels. The waveform image generator samples the source audio file in 600 places to obtain the 600 pixels for the visual representation. The result file is preferably created one time for a particular source file containing the audio information. The length of the waveform 228 represents the entire length of the song formed from the information in the audio track. It does not matter how long the song is because whether it is short or long, the asynchronous process will sample the audio file by the number of pixels that would be visually presented to the user.

At block 450, a window, such as the window 330, specifying a location at which a portion of the audio track would be converted and a length indicating a duration of the portion, is displayed to the user via the window. Using the window, the user is able to specify the start and end coordinates of the edges of the portion of the audio track for subsequent conversion. At block 452, the user may specify a different length (the options being limited by the ring tone duration supported by the telephonic mobile device). Given the starting point and the ending point provided by the window 230, the asynchronous process knows the approximate location in the audio track to begin the conversion and the ending point in the audio track to terminate the conversion. At block 454, the user may specify a volume boost to the portion of the audio track during conversion. Suitable volume boost selections include none, low, medium, high, and so on. The volume boost changes the amplitude of the selected portion of the audio track. Some models of telephonic mobile device may lack or have poor audio amplifiers and the volume boost facility may alleviate volume frustration associated with those models.

The method 400 proceeds to block 456 where the user may select a quality of the portion of the audio track such as low, medium, or high quality. In some cases, the user cannot select a quality because the model of the telephonic mobile device can support only one quality level. At block 458, the method adds fade-in and fade-out to a portion of the audio track. The selected portion of the audio track may be at a point in the audio progression that may be too harsh. The fade-in and fade-out insertions create a more gradual ingress and egress from the sound production of the audio so as to create a more pleasing sound. Next, at block 460, the method processes the portion of the audio track for the user to preview if the user selects a “preview” button. The method then continues to another continuation terminal (“terminal C3”).

From terminal C3 (FIG. 4F), the method emits a customizable, tag-based conversion file that contains conversion information, such as source file name, duration, start time, end time, target format, and so on. At block 464, the customizable, tag-based file is given a unique name with a process tag that identifies an asynchronous process which will grab the file to begin the conversion. The customizable, tag-based file is placed into a work order directory known to asynchronous processes that perform conversion. See block 466. When an asynchronous process identified by the process tag searches the work order history directory, it finds the file and begins the conversion. See block 468. At block 470, the asynchronous process creates a result file containing a preview portion in the directory labeled by the telephone number of the user. At block 472, the method streams the preview portion of the audio track toward the computer of the user. The preview portion is played on the computer of the user. See block 474. In one embodiment, the server 100 may present a pop-up window to play the preview portion, and in an alternative embodiment, the server 100 may use the preview window to play the preview portion without presenting any additional pop-up window. The method then continues to exit terminal D.

From terminal D (FIG. 4A), the method proceeds to a set of method steps 406 defined between a continuation terminal (“terminal E”) and the exit terminal F. The set of method steps 406 sends a portion of the audio track that has been converted into a ring tone to a telephonic mobile device as requested by the user.

From terminal E (FIG. 4G), the method proceeds to block 476 where the user selects the “send ring tone to phone” button using the user interface provided by the processing Web site. At block 478, the method emits a customizable, tag-based download file that contains download information, such as source file name, telephone number, device model, and so on. The customizable, tag-based file is given a unique name with a download tag that identifies an asynchronous process to grab the file to begin conversion. See block 480. At block 484, the customizable, tag-based file is placed into a work order directory known to asynchronous processes that perform the conversion. When an asynchronous process identified by the process tag searches the work order history directory, it finds the file. See block 486. Next, at block 488, the asynchronous process takes the selected portion of the audio track and converts it to the format and quality supported by the telephonic mobile device. At block 490, the asynchronous process electronically packages the converted portion of the audio track that is supported by the telephonic mobile device. At block 492, the asynchronous process creates a result file containing the downloadable package in the directory labeled by the telephone number of the user. Preferably, the result file includes a friendly name provided by the user to name his selected portion of the audio track. The method then continues to another continuation terminal (“terminal E1”).

From terminal E1 (FIG. 4H), the method sends a message to the telephonic mobile device using the telephone number. See block 494. At block 496, the message is a link to the location of the package comprising the URL of the processing Web site, the telephone number of the user, and a password. Preferably, the link is a hyperlink to a personalized Web page on the server 100 for the user to download his converted portion of the audio track to his telephonic mobile device. At block 498, the message is further modified to include a caching inhibitor tag at the end of the message that is different from other caching inhibitor tags sent previously. The caching inhibitor tag tunnels through the caching architecture used by telecommunication equipment by making the message appear to be a unique request to enable the user to access an updated personalized Web page and obtains the converted portion of the audio track.

Uploaded files, intermediate files, editing files, and other files are discarded, except the package for downloading. See block 499. At block 497, the telephonic mobile device receives the message and presents the link to the user to select. The message can be sent by a suitable communication means, such as SMS or WAP push. Preferably, the user's telephonic mobile device can be connected to the Internet. One suitable way of connecting to the Internet for a telephonic mobile device is for it to support WAP but other suitable protocols can be used. At block 495, upon selection, the personalized Web page is downloaded to the user's telephonic mobile device and all converted pieces of contents within a suitable amount of time are presented to the user. The user selects a piece of content and the package is downloaded to the telephonic mobile device and unpacked.

The method also buffers messages when they are sent out to the user in situations in which the telecommunication equipment may malfunction. The buffered messages can be repeatedly resent a number of times to the user until a threshold is reached or until successfully downloaded. The method then continues to terminal F and terminates execution.

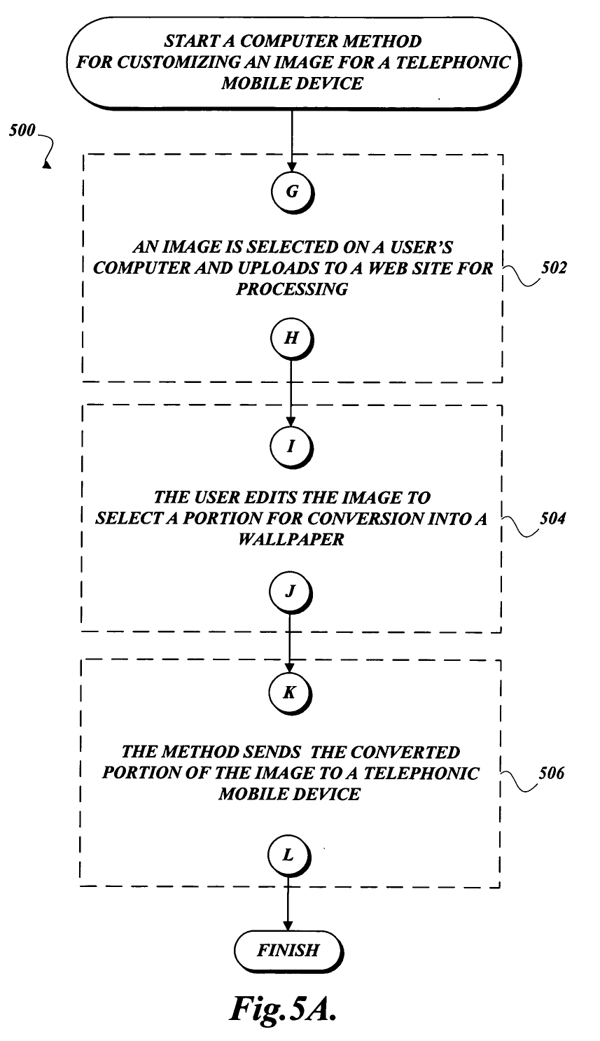

FIG. 5A illustrates a method for customizing an image for a telephonic mobile device. From a start block, the method 500 proceeds to a set of method steps 502 defined between continuation terminals (G and H). The set of method steps 502 describes that an image is selected on a user's computer and uploads to a Web site for processing. The set of method steps 502 is in many ways similar to method steps 402 described with respect to FIGS. 4A, albeit more specific to processing an image. Those steps are incorporated in full here but for brevity purposes are not be repeated.

From the set of method steps 502, the method 500 proceeds to another set of method steps 504 defined between continuation terminals (I and J). The set of method steps 504 describes that the user edits the image to select a portion for conversion into wallpaper. In many ways, the set of method steps 504 is similar to those steps connected with method steps 404 in FIG. 4A, albeit more specific to editing an image. The specific steps are incorporated in full here but for brevity purposes are not be repeated. The method tracks not only the image formats supported by a model of the telephonic mobile device but also the physical dimensions in terms of pixels of the screen of the telephonic mobile device.

An aspect ratio can be calculated from the physical dimensions of the screen. The method will allow the user to crop an image to fit perfectly onto the physical dimensions of the screen using the calculated aspect ratio. Conventional cellular phones do not make this calculation but attempt to squeeze an image onto the physical dimensions and thereby distort the image.

Specifically, the editor provided by the method steps 504 allows an image to be stretched to fit the resolution provided by the user interface of the system 100 or the maximum dimensions suitable for the telephonic mobile device. Additionally, a window having dimensions less than the actual image can be located on the image to specify the portion of the image to be converted. Furthermore, various visual effects can be applied to the selected portion of the image, such as overexposure, and a preview option is available for the user to see the result of the selection before causing the selection to be sent to the telephonic mobile device.

From the set of method steps 504, the method 500 proceeds to another set of method steps 506, defined between continuation terminals (K and L). The set of method steps 506 describes that the method sends the converted portion of the image to a telephonic mobile device. In many ways, the set of method steps 506 is similar to that of method steps 406, albeit more specific to an image. For brevity purposes, they are incorporated in full here but for brevity purposes are not be repeated. The method 500, after reaching terminal L, terminates execution. While illustrative embodiments have been illustrated and described, it will be appreciated that various changes can be made therein without departing from the spirit and scope of the invention.

The embodiments of the invention in which an exclusive property or privilege is claimed are defined as follows:

1. A computer-implemented method for converting media, comprising:
navigating to a Web site at which a piece of conversion software is running;
selecting a media file stored on a local computer using the conversion software;
uploading the media file to the Web site using the conversion software;
editing the contents of the uploaded media file to obtain a desired portion; and
converting the desired portion of the uploaded media file into a piece of media usable on a telephonic mobile device and sending a link that points to the desired portion to the telephonic mobile device using a tag that inhibits caching.

2. The computer-implemented method of claim 1, further comprising querying the user to pay for the converting if an account balance of the user is not current.

3. The computer-implemented method of claim 2, wherein the media file is a music file that contains audible media.

4. The computer-implemented method of claim 3, wherein editing includes presenting a ring tone editor that shows a waveform of the audible media with which the user can select a desired length and a desired volume.

5. The computer-implemented method of claim 4, further comprising previewing the piece of media usable on the cellular device at the desired length and at the desired volume.

6. The computer-implemented method of claim 2, wherein the media file is a picture file that contains picture media.

7. The computer-implemented method of claim 6, wherein editing includes presenting a picture editor that shows a picture of the picture media with which the user can select a picture effect and cropping.

8. The computer-implemented method of claim 7, further comprising previewing the piece of media usable on the cellular device with the picture effect and cropping.

9. A storable computer-readable medium having computer-executable instructions stored thereon for implementing a computer-implemented method for converting media, comprising:
navigating to a Web site at which a piece of conversion software is running;
selecting a media file stored on a local computer using the conversion software;
uploading the media file to the Web site using the conversion software;
editing the contents of the uploaded media file to obtain a desired portion; and
converting the desired portion of the uploaded media file into a piece of media usable on a telephonic mobile device and sending a link that points to the desired portion to the telephonic mobile device using a tag that inhibits caching.

10. The storable computer-readable medium of claim 9, further comprising querying the user to pay for the converting if an account balance of the user is not current.

11. The storable computer-readable medium of claim 10, wherein the media file is a music file that contains audible media.

12. The storable computer-readable medium of claim 11, wherein editing includes presenting a ring tone editor that shows a waveform of the audible media with which the user can select a desired length and a desired volume.

13. The storable computer-readable medium of claim 12, further comprising previewing the piece of media usable on the cellular device at the desired length and at the desired volume.

14. The storable computer-readable medium of claim 10, wherein the media file is a picture file that contains picture media.

15. The storable computer-readable medium of claim 14, wherein editing includes presenting a picture editor that shows a picture of the picture media with which the user can select a picture effect and cropping.

16. The storable computer-readable medium of claim 15, further comprising previewing the piece of media usable on the cellular device with the picture effect and cropping.

17. A networked system for converting media, comprising:
a telephonic mobile device;
a local computer usable to connect to a Web site that runs conversion software; and
a server on which the Web site is hosted for uploading a media file from the local computer to the Web site using the conversion software that edits and converts the media file into a piece of media usable by the telephonic mobile device when the piece of media is sent to the telephonic mobile device using a tag that inhibits caching.

18. The networked system of claim 17, wherein the telephonic mobile device includes a cellular phone.

19. The networked system of claim 17, wherein the telephonic mobile device includes a PDA.

20. The networked system of claim 17, wherein the telephonic mobile includes a number that is a cellular telephone number.
